(19) United States
(12) Patent Application Publication
(10) Pub. No.: US 2016/0099795 A1
(43) Pub. Date: Apr. 7, 2016

(54) TECHNOLOGIES FOR EXCHANGING HOST LOSS AND FORWARD ERROR CORRECTION CAPABILITIES ON A 25G ETHERNET LINK

(71) Applicants: Kent C. Lusted, Aloha, OR (US); Adee O. Ran, Maayan Baruch (IL); Richard I. Mellitz, Prosperity, SC (US)

(72) Inventors: Kent C. Lusted, Aloha, OR (US); Adee O. Ran, Maayan Baruch (IL); Richard I. Mellitz, Prosperity, SC (US)

(21) Appl. No.: 14/580,731

(22) Filed: Dec. 23, 2014

Related U.S. Application Data
(60) Provisional application No. 62/059,023, filed on Oct. 2, 2014.

(51) Int. Cl. H04L 1/00; G06F 11/10

(52) U.S. Cl. CPC H04L 1/0041; G06F 11/10

(57) ABSTRACT

Technologies for capabilities exchange include a network port logic having a communication link coupled to a remote link partner. The port logic transmits local host loss information to the link partner and receives remote host loss information from the link partner. The port logic may communicate the host loss information via an autonegotiation base page, an autonegotiation next page, or a PMD control frame. The port logic determines total channel loss based on the local host loss, the remote host loss, and cable loss. The port logic may bring the communication link up without forward error correction (FEC) if the total channel loss is less than a FEC limit, may bring the link up with FEC if the total loss is less than a specification limit, or may not bring the link up if the total channel loss is above the specification limit. Other embodiments are described and claimed.

### CROSS-REFERENCE TO RELATED APPLICATION

The present application claims priority under 35 U.S.C. §119(e) to U.S. Provisional Patent Application Ser. No. 62/059,023, entitled “TECHNOLOGIES FOR EXCHANGING HOST LOSS AND FORWARD ERROR CORRECTION CAPABILITIES ON A 25G ETHERNET LINK,” which was filed on Oct. 2, 2014.

### BACKGROUND

Ethernet standards for communication over copper conductors typically define budgets for allowed signal loss. For example, the total link budget for 100GBASE-CR4 is about 35 dB at the Nyquist frequency. Of the total link budget, about 6 dB insertion loss at the Nyquist frequency is allocated to each host and about 22 dB at the Nyquist frequency is allocated to the cable. For 25 gigabit (Gb) Ethernet over copper cabling, a larger host insertion loss budget may be allowed, for example to allow longer PCB communication routes or to use lower-cost materials. For example, 25 Gb Ethernet may allocate about 9 dB to each host. In that example, about 16 dB may be allocated to the cable.

Additionally, Ethernet standards define methods for forward error correction (FEC), such as Reed Solomon FEC (RS-FEC) specified by clause 91 of IEEE standard 802.3bj (2014) or FEC specified by clause 74 of IEEE standard 802.3 (2012). FEC may allow a receiver to identify or correct transmission errors, which may provide coding gain to effectively increase the total link budget and improve bit error ratio (BER) performance. For certain standards, FEC may be optional, and FEC logic may or may not be enabled in a host. The host loss and FEC capabilities of a link partner are typically unknown to the local host.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of Ethernet port logic for exchanging host loss and FEC capabilities;

FIG. 2 is a simplified block diagram of at least one embodiment of an environment of the Ethernet port logic of FIG. 1;

FIG. 3 is a simplified block diagram of at least one embodiment of a computing device that may include the Ethernet port logic of FIGS. 1 and 2;

FIGS. 4A and 4B are simplified flow diagrams of at least one embodiment of a method for exchanging host loss and FEC capabilities that may be executed by the Ethernet port logic of FIGS. 1 and 2; and

FIG. 5 is a schematic diagram of embodiments of autonegotiation pages that may be used by the Ethernet port logic of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C): (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

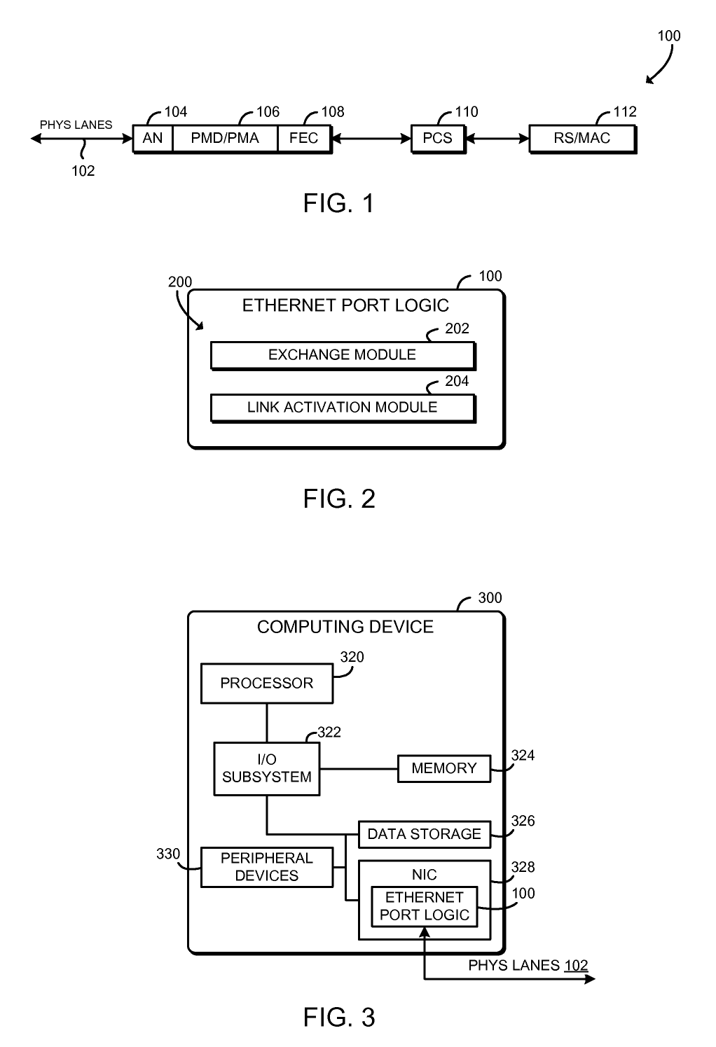

Referring now to FIG. 1, an Ethernet port logic 100 is configured to communicate over one or more physical communication lanes 102. In the illustrative embodiment, the Ethernet port logic 100 is configured to exchange information on host capabilities with a link partner, including host insertion loss information and forward error correction (FEC) capabilities. The Ethernet port logic 100 is also configured to determine whether to bring up the communications link and whether to enable FEC based on the exchanged capabilities information. Thus, the Ethernet port logic 100 is able to determine the total channel loss, which may be used to determine whether the connected cable loss is acceptable and/or whether FEC is required. Bypassing FEC, if possible, may enable lower communication latency. Additionally, although illustrated as an Ethernet port logic 100, it should be understood that the Ethernet port logic 100 may be embodied as any network port logic implementing a different network architecture that is capable of implementing the functions described herein.

The illustrative Ethernet port logic 100 includes an autonegotiation module 104, a physical medium dependent (PMD) sublayer/physical medium attachment (PMA) sublayer module 106, a forward error correction (FEC) sublayer 108, a physical coding sublayer (PCS) 110, and a reconciliation sublayer/media access control sublayer (MAC) 112. Additionally, in some embodiments, one or more of the illustrative components may be incorporated in, or otherwise form a portion of, another component. For example, part or all of the autonegotiation module 104, the PMD/PMA 106, and/or the FEC 108 may be incorporated in the PCS 110.

The communication lanes 102 may be embodied as any one or more computer communication links. For example, each communication lane 102 may be embodied as a twinaxial copper cable or as an electrical backplane connection. In some embodiments, each communication lane 102 may be capable of full-duplex operation. For example, each communication lane 102 may include two twinaxial pairs of electrical conductors, one pair for transmitting data and the other pair for receiving data. Illustratively, the communication lanes 102 may include a single communication lane 102 operating at 25 Gb/s. As another example, the communication lanes 102 may include four communication lanes 102 operating at 25 Gb/s each, for 100 Gb/s of total bandwidth. Although described as operating at a data rate such as 25 Gb/s, it should be understood that in some embodiments each of the communications lanes 102 may operate at a slightly higher signaling rate such as 25.78125 Gb/s, to allow for additional data for line encoding, error correction, and other additional data.

The autonegotiation module 104 is configured to auto-negotiate line transmission speed, mode of operation, and other communication parameters with a link partner when the communication lane 102 is brought up. Additionally, in some embodiments the autonegotiation module 104 may be configured to exchange capabilities information with the link partner including host insertion loss information, RS-FEC ability information, and RS-FEC request information. The autonegotiation module 104 may encode the capabilities information, for example, in an autonegotiation base page or in a next page. Although illustrated in FIG. 1 as coupled between the PMD/PMA 106 and the communication lanes 102, in other embodiments the autonegotiation module 104 may be included at different positions in the Ethernet port logic 100. For example, in some embodiments the autonegotiation module 104 may be coupled between the PMD/PMA 106 and the FEC 108.

The PMD/PMA 106 is configured to transmit and receive serial binary data over the communication lanes 102. Additionally, in some embodiments the PMD/PMA 106 may be configured to exchange capabilities information with the link partner including host insertion loss information, RS-FEC ability information, and RS-FEC request information. The PMD/PMA 106 may encode the capabilities information, for example, in a PMD control frame.

The FEC 108 is configured to apply a forward error correction code to the data passed between the PMD/PMA 106 and the PCS 110. In other words, the FEC 108 may encode data passed from the PCS 110 to the PMD/PMA 106 and decode data passed from the PMD/PMA 106 to the PCS 110. The forward error correction code may improve the reliability of data transmission at higher line speeds. In the illustrative embodiment, the FEC 108 applies a Reed-Solomon forward error correction code (RS-FEC). In other embodiments, the FEC 108 may apply any appropriate forward error correction code, such as the FEC described by clause 74 of the IEEE standard 802.3 (2012). In some embodiments, the FEC 108 may be selectively bypassed or otherwise selectively enabled or disabled.

The PCS 110 is configured to encode Ethernet frame data received from the MAC 112 into encoded data blocks that may be transmitted by the PMD/PMA 106, and to decode data received from the PMD/PMA 106 into decoded Ethernet frame data that may be processed by the MAC 112. The PCS 110 may encode and distribute the data blocks over one or more logical PCS lanes. The PCS 110 may encode data for transmission over the communication lanes 102 for example, to improve communication efficiency. For example, encoding the data may add timing or synchronization symbols, align the data, add state transitions to the encoded data to improve clock recovery, adjust the DC balance of the data signal, or otherwise prepare the encoded data for serial transmission. The PCS 110 may be capable of encoding or decoding the data using a 64b/66b line code in which 64-bit blocks of data are encoded into 66-bit blocks of encoded data, and vice versa.

The MAC 112 is configured to transmit Ethernet frame data to the PCS 110 to be encoded and transmitted, and to receive data from the PCS 110 produce Ethernet frame data. The MAC 112 may perform Ethernet frame detection and validation, packet reception and transmission, cyclic redundancy check (CRC) validation, CRC computation, and other media access control sublayer operations.

Referring now to FIG. 2, in the illustrative embodiment, the Ethernet port logic 100 establishes an environment 200 during operation. The illustrative embodiment 200 includes an exchange module 202 and a link activation module 204. The various modules of the environment 200 may be embodied as hardware, firmware, software, or a combination thereof. For example the various modules, logic, and other components of the environment 200 may form a portion of, or otherwise be established by, the autonegotiation module 104, the PMD/PMA module 106, or other hardware components of the Ethernet port logic 100. As such, in some embodiments, any one or more of the modules of the environment 200 may be embodied as a circuit or collection of electrical devices (e.g., an exchange circuit and/or a link activation circuit).

The exchange module 202 is configured to communicate capabilities information with a remote link partner including host loss information, RS-FEC ability information, and RS-FEC request information. The exchange module 202 may transmit local host loss information to the link partner and receive remote host loss information from the link partner. In some embodiments, the exchange module 202 may be included in or otherwise established by the autonegotiation module 104 and thus the capabilities information may be exchanged during execution of an autonegotiation protocol. In some embodiments, the exchange module 202 may be included in or otherwise established by the PMD/PMA module 106 and thus the capabilities information may be exchanged during a startup protocol performed by the PMD/PMA module 106.

The link activation module 204 is configured to determine a total insertion loss for the connection with the remote host based on the local host loss, the remote host loss, and cable loss. The link activation module 204 compares the total insertion loss to a FEC limit and to a specification limit. The link activation module 204 may bring up the communication link with the link partner without FEC enabled if the total insertion loss is below the specification limit and below the FEC limit. Additionally, the link activation module 204 may bring up the communication link with the link partner with FEC enabled if the total insertion loss is below the specification limit but not below the FEC limit. Further, the link activation module 204 may not bring up the communication link with the link partner if the total insertion loss is not below the specification limit (e.g., the link activation module 204 may keep the communication link down or bring the communication link down).

Referring now to FIG. 3, in an illustrative embodiment, a computing device 300 may include the Ethernet port logic 100. The computing device 300 may be embodied as any type of computation or computer device capable of performing the functions described herein, including, without limitation, a computer, a smartphone, a tablet computer, a laptop computer, a notebook computer, a mobile computing device, a wearable computing device, a multiprocessor system, a server, a rack-mounted server, a blade server, a network appliance, a web appliance, a distributed computing system, a processor-based system, and/or a consumer electronic device. As shown in FIG. 1, the computing device 300 illustratively includes a processor 320, an input/output subsystem 322, a memory 324, a data storage device 326, and a network interface circuit or card (NIC) 328. Of course, the computing device 300 may include other or additional components, such as those commonly found in a computer (e.g., various input/output devices), in other embodiments. Additionally, in some embodiments, one or more of the illustrative components may be incorporated in, or otherwise form a portion of, another component. For example, the memory 324, or portions thereof, may be incorporated in the processor 320 in some embodiments.

The processor 320 may be embodied as any type of processor capable of performing the functions described herein. For example, the processor 320 may be embodied as a single or multi-core processor(s), digital signal processor, microcontroller, or other processor or processing/controlling circuit. Similarly, the memory 324 may be embodied as any type of volatile or non-volatile memory or data storage capable of performing the functions described herein. In operation, the memory 324 may store various data and software used during operation of the computing device 300 such as operating systems, applications, programs, libraries, and drivers. The memory 324 is communicatively coupled to the processor 320 via the I/O subsystem 322, which may be embodied as circuitry and/or components to facilitate input/output operations with the processor 320, the memory 324, and other components of the computing device 300. For example, the I/O subsystem 322 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 322 may form a portion of a system-on-a-chip (SoC) and be incorporated, along with the processor 320, the memory 324, and other components of the computing device 300, on a single integrated circuit chip. The data storage device 326 may be embodied as any type of device or devices configured for short-term or long-term storage of data such as, for example, memory devices and circuits, memory cards, hard disk drives, solid-state drives, or other data storage devices.

The NIC 328 may connect the computing device 300 to one or more computing devices, network devices, switches, remote hosts, or other devices. The NIC 328 may be embodied as one or more add-in-boards, daughtercards, network interface cards, controller chips, chipsets, or other devices that may be used by the computing device 300 for network communications with remote devices. For example, the NIC 328 may be embodied as an expansion card coupled to the I/O subsystem 322 over an expansion bus such as PCI Express. In the illustrative embodiment, the NIC 328 includes a single Ethernet port logic 100 to connect to the remote devices. Of course, in other embodiments the computing device 300 may include additional or fewer Ethernet port logics 100 to support a different number of communication lanes 102.

In some embodiments, the computing device 300 may also include one or more peripheral devices 330. The peripheral devices 330 may include any number of additional input/output devices, interface devices, and/or other peripheral devices. For example, in some embodiments, the peripheral devices 330 may include a display, touch screen, graphics circuitry, keyboard, mouse, speaker system, network interface, and/or other input/output devices, interface devices, and/or peripheral devices.

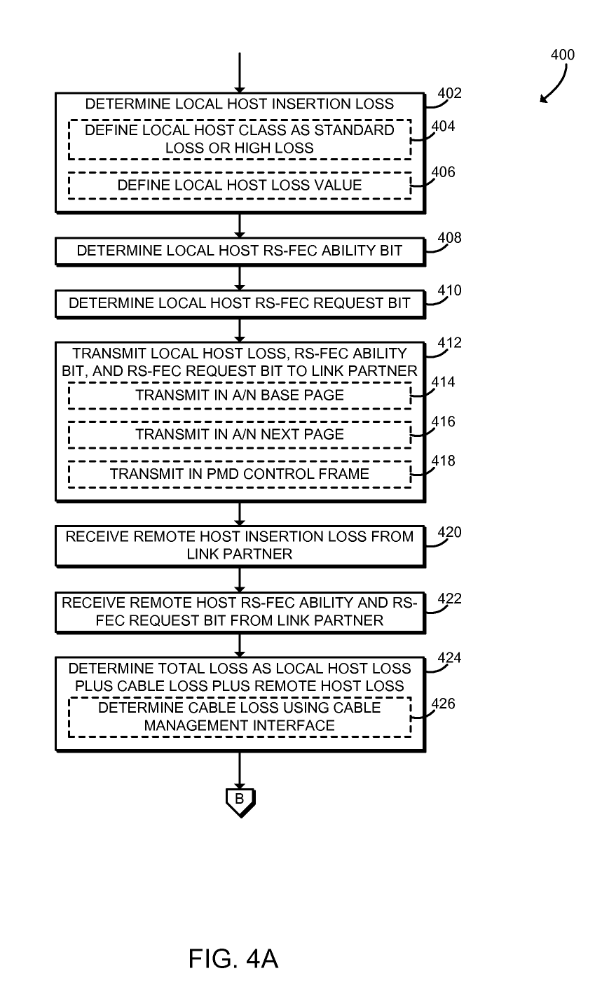

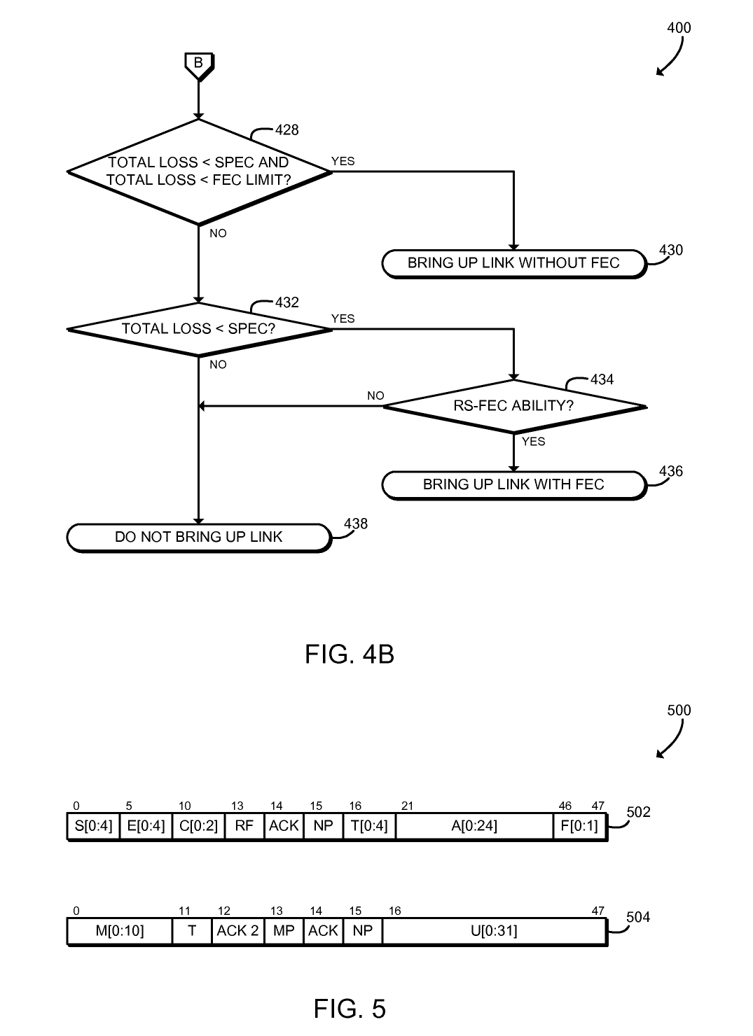

Referring now to FIGS. 4A and 4B, in use, the Ethernet port logic 100 may execute a method 400 for exchanging host loss and forward error correction information with a remote link partner. The method 400 begins in block 402, in which the Ethernet port logic 100 determines the local host insertion loss. The Ethernet port logic 100 may use any technique to determine the local host loss. For example, the Ethernet port logic 100 may be configured with a predefined local host loss. In some embodiments, in block 404, the Ethernet port logic 100 may define the local host class as a standard loss host (e.g., class 1) or a high loss host (e.g., class 2) based on the local host loss. A standard loss host may be defined as a host insertion loss of about 6 dB at the Nyquist frequency (e.g., 12.8906 GHz). A high loss host may be defined as a host insertion loss of about 9 dB at the Nyquist frequency. The local host class may be represented as a single bit (e.g., logical zero for standard loss host and logical one for high loss host). In some embodiments, in block 406, the Ethernet port logic 100 may define the local host loss value. For example, the Ethernet port logic 100 may determine the local host loss value in dB (e.g., 6 dB or 9 dB at the Nyquist frequency).

In block 408, the Ethernet port logic 100 determines the local host RS-FEC ability bit (e.g., logical one if the Ethernet port logic 100 is capable of RS-FEC and logical zero if the Ethernet port logic 100 is not capable of RS-FEC). The Ethernet port logic 100 may use any technique to determine the RS-FEC ability bit. For example, the Ethernet port logic 100 may be configured with a predefined RS-FEC ability bit, or the RS-FEC ability bit may be configurable by a user or an administrator.

In block 410, the Ethernet port logic 100 determines the local host RS-FEC request bit (e.g., logical one if the Ethernet port logic 100 requests RS-FEC and logical zero if the Ethernet port logic 100 does not request of RS-FEC). To determine the RS-FEC request bit, the Ethernet port logic 100 may follow a truth table similar to the IEEE standard 802.3 clause 74 FEC (i.e., it is invalid to request RS-FEC if the Ethernet port logic 100 does not have that ability).

In block 412, the Ethernet port logic 100 transmits the local host loss, the RS-FEC ability bit, and the RS-FEC request bit as determined above in connection with blocks 402 to 410 to the link partner. In some embodiments, in block 414, the Ethernet port logic 100 may transmit the local host loss, the RS-FEC ability bit, and the RS-FEC request bit in an autonegotiation base page, also known as a base link codeword. The Ethernet port logic 100 may define the host classes as physical layer types in the base page. For example, clause 73 of the IEEE standard 802.3 (2012) defines an encoding for a 48-bit base page transmitted during the autonegotiation process. The base page may be transmitted in a differential Manchester encoding page including the 48-bit base page plus one random bit. The base page includes a 25-bit wide Technology Ability Field (bits A[24:0]). The Ethernet port logic 100 may use two reserved bits of the Technology Ability Field to encode the host loss class. For example, bit A9 may encode the standard loss host class (i.e., “25GBase-CR class 1”), and bit A10 may encode the high loss host class (i.e., “25GBase-CR class 2”). In that example, the high loss host class may be defined to have a higher priority and the standard loss host class may be defined to have a lower priority as defined in Table 73-5 of the IEEE standard 802.3 (2012), allowing the Ethernet port logic 100 and the link partner to resolve the host class properly. Similarly, the RS-FEC ability bit and the RS-FEC request bit may be encoded as reserved bits of the base page. For example, bits A[23:24] may be used to represent the RS-FEC ability bit and the RS-FEC request bit.

Referring now to FIG. 5, the diagram 500 illustrates one potential embodiment of a base page 502. As shown, the base page 502 includes 48 bits organized into several bits and groups of bits called fields. In particular, the base page 502 includes a selector field S, an echoed nonce field E, a capability field C, a remote fault bit RF, an ACK bit, a next page bit NP, a transmitted nonce field T, a technology ability field A, and a forward error correction capability field F. As described above, the host loss class may be encoded in bits 9 and 10 of the ability field A, and the RS-FEC ability bit and the RS-FEC request bit may be encoded in bits 23 and 24 of the ability field A, respectively. The FEC capability field F may encode FEC ability and FEC request bits as described in clause 73.6.5 of the IEEE standard 802.3 (2012).

Referring back to FIG. 4A, in some embodiments, in block 416 the Ethernet port logic 100 transmits the local host loss, the RS-FEC ability bit, and the RS-FEC request bit in an autonegotiation message next page. The autonegotiation protocol described in clause 73 of the IEEE 802.3 defines encodings for 48-bit “next pages” that may be transmitted after transmission of the base page, including message next pages and unformatted next pages. Each message next page may include an 11-bit message code field D[10:0], M[10:0] and a 32-bit unformatted code field D[47:16], U[31:0]. To transmit the local host loss, the RS-FEC ability bit, and the RS-FEC request bit, the message code field M[10:0] may be set to a unique identifier (e.g., the number 16 represented in binary). In the message next page, the unformatted code field D[47:16] may include the supported capabilities of the Ethernet port logic 100. For example, one bit (e.g., U₀) may define the Ethernet port logic 100 as “standard loss” or “high loss.” Continuing that example, two bits (e.g., U[2:1]) may define the RS-FEC ability bit and RS-FEC request bit.

Referring again to FIG. 5, the diagram 500 illustrates one potential embodiment of a message next page 504. As shown, the message next pages 504 includes 48 bits organized into several bits and groups of bits called fields (not to scale). The message next page 504 includes both a message code field M and an unformatted code field U. In particular, the message next page includes the message code field M, a toggle bit T, an acknowledge 2 bit ACK 2, a message page bit MP (always set for message next pages 504), an acknowledge bit ACK, a next page bit NP, and the unformatted code field U. As described above, the message code field M may include a unique identifier (e.g., 0x10), and the host loss class, the RS-FEC request bit, and the RS-FEC ability bit may be encoded in bits 0-2 of the unformatted code field U.

Referring back to FIG. 4A, in some embodiments, in block 418 the Ethernet port logic 100 transmits the local host loss, the RS-FEC ability bit, and the RS-FEC request bit in a PMD control frame. As described in clause 726.10 of the IEEE standard 802.3 (2012), during startup the PMD/PMA 106 may continuously transmit training frames including a control channel. The training frames may be embodied as, for example, a sequence of bits that is 548 octets in length. The control channel may be embodied as 32 octets of each training frame. The Ethernet port logic 100 may assign bits of the control channel to the local host loss class, the RS-FEC ability bit, and the RS-FEC request bit.

In block 420, the Ethernet port logic 100 receives the remote host insertion loss from the link partner. As described above in connection with block 402, the remote host insertion loss may be represented as a remote host class (e.g., standard loss or high loss) or as a remote host lost value (e.g., 6 dB or 9 dB). The Ethernet port logic 100 may receive the remote host insertion loss using the same technique used to transmit the local host insertion loss as described above in connection with block 412. For example, the Ethernet port logic 100 may receive the remote host insertion loss in an autonegotation base page, in an autonegotation next page, or in a PMD control frame. Additionally, although illustrated as receiving the remote host insertion loss sequentially after transmitting the local host insertion loss, it should be understood that the Ethernet port logic 100 may receive the remote host insertion loss at a different time or at the same time (i.e., using full-duplex communication capability).

Similarly, in block 422, the Ethernet port logic 100 receives the remote host RS-FEC ability bit and the remote host RS-FEC request bit from the link partner. The Ethernet port logic 100 may receive the remote host RS-FEC ability bit and the remote host RS-REC request bit using the same technique used to transmit the local host insertion loss as described above in connection with block 412. For example, the Ethernet port logic 100 may receive the remote host RS-FEC ability bit and the remote host RS-REC request bit in an autonegotation base link codeword, in an autonegotation next page, or in a PMD control frame. Additionally, although illustrated in separate blocks, it should be understood that the Ethernet port logic 100 may receive the remote host RS-FEC ability, the RS-FEC request bit, and the remote host insertion loss at the same time or at different times.

In block 424, the Ethernet port logic 100 determines the total channel loss as the local host loss plus the cable loss plus the remote host loss. Equation 1, below, illustrates one potential embodiment of an equation for calculation of the total channel loss. Total channel loss may be expressed as a value in dB at the Nyquist frequency. Thus, the Ethernet port logic 100 may use the link partner's loss classification and FEC capabilities to compute an overall link budget margin. In some embodiments, in block 426 the Ethernet port logic 100 may determine the cable loss using a cable management interface coupled to the Ethernet port logic 100.

Tₗₒₛₛ=local_host_loss+cable_loss+remote_host_loss (1)

Referring now to FIG. 4B, in block 428, the Ethernet port logic 100 determines whether the total channel loss is less than a specification loss limit and whether the total channel loss is also less than a FEC threshold. The specification loss limit may be predefined by a standard such as the IEEE standard 802.3 (2012). For example, the specification loss limit may be defined as 35 dB. The FEC threshold may be an amount of signal loss that is below the specification loss limit, but above which FEC is required for successful transmission. If the total channel loss is less than the specification loss limit and less than the FEC threshold, the method 400 branches to block 430, in which the Ethernet port logic 100 brings up the communication link with the link partner without using FEC. If the total channel loss is not both less than the specification loss limit and less than the FEC threshold, the method 400 advances to block 432.

In block 432, the Ethernet port logic 100 determines whether the total channel loss is less than the specification loss limit. If so, the method 400 branches to block 434. In block 434, the Ethernet port logic 100 determines whether both link partners (the local host and the remote link partner) have the ability to enable FEC. The Ethernet port logic 100 may determine, for example, whether the RS-FEC ability bit of the local host, determined as described in block 408 above, and the RS-FEC ability bit of the remote link partner, received as described above in block 422, are both set. If not, the method 400 branches to block 438, described below. If both link partners are capable of enabling FEC, the method 400 advances to block 436, in which the Ethernet port logic 100 brings up the communication link with the link partner using FEC. For example, the Ethernet port logic 100 may enable transcoding and RS-FEC, may enable FEC as described by clause 74 of the IEEE standard 802.3 (2012), or may enable any other appropriate FEC scheme.

Referring back to block 432, if the total channel loss is not less than the specification loss limit (or if either link partner is not capable of enabling FEC), the method 400 branches to block 438, in which the Ethernet port logic 100 does not bring up the communication link with the remote link partner. The Ethernet port logic 100 may, for example, bring the link down, deactivate the link, or otherwise keep the link from being activated.

### EXAMPLES

Illustrative examples of the technologies disclosed herein are provided below. An embodiment of the technologies may include any one or more, and any combination of, the examples described below.

Example 1 includes a network interface circuit for exchanging capabilities information, the network interface circuit comprising network port logic including an exchange module to (i) transmit local host insertion loss information to a remote link partner and (ii) receive remote host insertion loss information from the remote link partner; and a link activation module to determine a total insertion loss as a function of the local host insertion loss information and the remote host insertion loss information; determine whether the total insertion loss has a predetermined relationship to a predetermined forward error correction (FEC) limit; and activate a communication link with the remote link partner without using FEC in response to a determination that the total insertion loss has the predetermined relationship with the FEC limit.

Example 2 includes the subject matter of Example 1, and wherein to determine whether the total insertion loss has the predetermined relationship to the predetermined FEC limit comprises to determine whether the total insertion loss is less than the FEC limit.

Example 3 includes the subject matter of any of Examples 1 and 2, and wherein the link activation module is further to determine whether the total insertion loss has a predetermined relationship to a predetermined specification limit; and activate the communication link using FEC in response to a determination that the total insertion loss does not have the predetermined relationship to the FEC limit and a determination that the total insertion loss has the predetermined relationship to the specification limit.

Example 4 includes the subject matter of any of Examples 1-3, and wherein to determine whether the total insertion loss has the predetermined relationship to the predetermined FEC limit comprises to determine whether the total insertion loss is less than the FEC limit; and to determine, by the network port logic, whether the total insertion loss has the predetermined relationship to the predetermined specification limit comprises to determine whether the total insertion loss is less than the specification limit.

Example 5 includes the subject matter of any of Examples 1-4, and wherein the link activation module is further to deactivate the communication link in response to a determination that the total insertion loss does not have the predetermined relationship to the specification limit.

Example 6 includes the subject matter of any of Examples 1-5, and wherein the local host insertion loss information comprises a host class selected from a standard loss host or a high loss host; and the remote host insertion loss information comprises a host class selected from a standard loss host or a high loss host.

Example 7 includes the subject matter of any of Examples 1-6, and wherein the local host insertion loss information comprises a local host loss value; and the remote host insertion loss information comprises a remote host loss value.

Example 8 includes the subject matter of any of Examples 1-7, and wherein the exchange module is further to transmit an FEC ability bit and an FEC request bit to the remote link partner; and receive a remote FEC ability bit and a remote FEC request bit from the remote link partner.

Example 9 includes the subject matter of any of Examples 1-8, and wherein the link activation module is further to determine whether the total insertion loss has a predetermined relationship to a predetermined specification limit; determine whether the remote FEC ability bit is set; and activate the communication link using FEC in response to a determination that the remote FEC ability is set, a determination that the total insertion loss does not have the predetermined relationship to the FEC limit, and a determination that the total insertion loss has the predetermined relationship to the specification limit.

Example 10 includes the subject matter of any of Examples 1-9, and wherein the link activation module is further to determine whether the FEC ability bit is set; wherein to activate the communication link using FEC further comprises to activate the communication link using FEC in response to a determination that the FEC ability bit is set.

Example 11 includes the subject matter of any of Examples 1-10, and further including an autonegotiation module, wherein the autonegotiation module includes the exchange module, and wherein to transmit the local host insertion loss information comprises to encode the local host insertion loss information in an autonegotiation base page; and transmit the autonegotiation base page to the remote link partner.

Example 12 includes the subject matter of any of Examples 1-11, and further including an autonegotiation module, wherein the autonegotiation module includes the exchange module, and wherein to transmit the local host insertion loss information comprises to encode the local host insertion loss information in an autonegotiation next page; and transmit the autonegotiation next page to the remote link partner.

Example 13 includes the subject matter of any of Examples 1-12, and further including a physical medium dependent (PMD) module, wherein the PMD module includes the exchange module, and wherein to transmit the local host insertion loss information comprises to encode the local host insertion loss information in a physical medium dependent (PMD) control frame; and transmit the PMD control frame to the remote link partner.

Example 14 includes the subject matter of any of Examples 1-13, and wherein to determine the total insertion loss comprises to add the local host insertion loss, the remote host insertion loss, and a cable loss to determine the total insertion loss.

Example 15 includes the subject matter of any of Examples 1-14, and wherein the link activation module is further to determine the cable loss using a cable management interface.

Example 16 includes the subject matter of any of Examples 1-15, and wherein the communication link with the remote link partner comprises a 25-gigabit copper cable link.

Example 17 includes a method for exchanging capabilities information, the method comprising transmitting, by a network port logic, local host insertion loss information to a remote link partner; receiving, by the network port logic, remote host insertion loss information from the remote link partner; determining, by the network port logic, a total insertion loss as a function of the local host insertion loss information and the remote host insertion loss information; determining, by the network port logic, whether the total insertion loss has a predetermined relationship to a predetermined forward error correction (FEC) limit; and activating, by the network port logic, a communication link with the remote link partner without using FEC in response to determining that the total insertion loss has the predetermined relationship with the FEC limit.

Example 18 includes the subject matter of Example 17, and wherein determining whether the total insertion loss has the predetermined relationship to the predetermined FEC limit comprises determining whether the total insertion loss is less than the FEC limit.

Example 19 includes the subject matter of any of Examples 17 and 18, and further including determining, by the network port logic, whether the total insertion loss has a predetermined relationship to a predetermined specification limit; and activating, by the network port logic, the communication link using FEC in response to determining that the total insertion loss does not have the predetermined relationship to the FEC limit and that the total insertion loss has the predetermined relationship to the specification limit.

Example 20 includes the subject matter of any of Examples 17-19, and wherein determining whether the total insertion loss has the predetermined relationship to the predetermined FEC limit comprises determining whether the total insertion loss is less than the FEC limit; and determining, by the network port logic, whether the total insertion loss has the predetermined relationship to the predetermined specification limit comprises determining whether the total insertion loss is less than the specification limit.

Example 21 includes the subject matter of any of Examples 17-20, and further including deactivating, by the network port logic, the communication link in response to determining that the total insertion loss does not have the predetermined relationship to the specification limit.

Example 22 includes the subject matter of any of Examples 17-21, and wherein the local host insertion loss information comprises a host class selected from a standard loss host or a high loss host; and the remote host insertion loss information comprises a host class selected from a standard loss host or a high loss host.

Example 23 includes the subject matter of any of Examples 17-22, and wherein the local host insertion loss information comprises a local host loss value; and the remote host insertion loss information comprises a remote host loss value.

Example 24 includes the subject matter of any of Examples 17-23, and further including transmitting, by the network port logic, an FEC ability bit and an FEC request bit to the remote link partner; and receiving, by the network port logic, a remote FEC ability bit and a remote FEC request bit from the remote link partner.

Example 25 includes the subject matter of any of Examples 17-24, and further including determining, by the network port logic, whether the total insertion loss has a predetermined relationship to a predetermined specification limit; determining, by the network port logic, whether the remote FEC ability bit is set; and activating, by the network port logic, the communication link using FEC in response to determining that the remote FEC ability is set, that the total insertion loss does not have the predetermined relationship to the FEC limit, and that the total insertion loss has the predetermined relationship to the specification limit.

Example 26 includes the subject matter of any of Examples 17-25, and further including determining, by the network port logic, whether the FEC ability bit is set; wherein activating the communication link using FEC further comprises activating the communication link using FEC in response to determining the FEC ability bit is set.

Example 27 includes the subject matter of any of Examples 17-26, and wherein transmitting the local host insertion loss information comprises encoding the local host insertion loss information in an autonegotiation base page; and transmitting the autonegotiation base page to the remote link partner.

Example 28 includes the subject matter of any of Examples 17-27, and wherein transmitting the local host insertion loss information comprises encoding the local host insertion loss information in an autonegotiation next page; and transmitting the autonegotiation next page to the remote link partner.

Example 29 includes the subject matter of any of Examples 17-28, and wherein transmitting the local host insertion loss information comprises encoding the local host insertion loss information in a physical medium dependent (PMD) control frame; and transmitting the PMD control frame to the remote link partner.

Example 30 includes the subject matter of any of Examples 17-29, and wherein determining the total insertion loss comprises adding the local host insertion loss, the remote host insertion loss, and a cable loss to determine the total insertion loss.

Example 31 includes the subject matter of any of Examples 17-30, and further including determining, by the network port logic, the cable loss using a cable management interface.

Example 32 includes the subject matter of any of Examples 17-31, and wherein the communication link with the remote link partner comprises a 25-gigabit copper cable link.

Example 33 includes a computing device comprising a processor; and a memory having stored therein a plurality of instructions that when executed by the processor cause the computing device to perform the method of any of Examples 17-32.

Example 34 includes one or more machine readable storage media comprising a plurality of instructions stored thereon that in response to being executed result in a computing device performing the method of any of Examples 17-32.

Example 35 includes a computing device comprising means for performing the method of any of Examples 17-32.

Example 36 includes a network port logic for exchanging capabilities information, the network port logic comprising means for transmitting local host insertion loss information to a remote link partner; means for receiving remote host insertion loss information from the remote link partner; means for determining a total insertion loss as a function of the local host insertion loss information and the remote host insertion loss information; means for determining whether the total insertion loss has a predetermined relationship to a predetermined forward error correction (FEC) limit; and means for activating a communication link with the remote link partner without using FEC in response to determining that the total insertion loss has the predetermined relationship with the FEC limit.

Example 37 includes the subject matter of Example 36, and wherein the means for determining whether the total insertion loss has the predetermined relationship to the predetermined FEC limit comprises means for determining whether the total insertion loss is less than the FEC limit.

Example 38 includes the subject matter of any of Examples 36 and 37, and further including means for determining whether the total insertion loss has a predetermined relationship to a predetermined specification limit; and means for activating the communication link using FEC in response to determining that the total insertion loss does not have the predetermined relationship to the FEC limit and that the total insertion loss has the predetermined relationship to the specification limit.

Example 39 includes the subject matter of any of Examples 36-38, and wherein the means for determining whether the total insertion loss has the predetermined relationship to the predetermined FEC limit comprises means for determining whether the total insertion loss is less than the FEC limit; and the means for determining whether the total insertion loss has the predetermined relationship to the predetermined specification limit comprises means for determining whether the total insertion loss is less than the specification limit.

Example 40 includes the subject matter of any of Examples 36-39, and further including means for deactivating the communication link in response to determining that the total insertion loss does not have the predetermined relationship to the specification limit.

Example 41 includes the subject matter of any of Examples 36-40, and wherein the local host insertion loss information comprises a host class selected from a standard loss host or a high loss host; and the remote host insertion loss information comprises a host class selected from a standard loss host or a high loss host.

Example 42 includes the subject matter of any of Examples 36-41, and wherein the local host insertion loss information comprises a local host loss value; and the remote host insertion loss information comprises a remote host loss value.

Example 43 includes the subject matter of any of Examples 36-42, and further including means for transmitting an FEC ability bit and an FEC request bit to the remote link partner; and means for receiving a remote FEC ability bit and a remote FEC request bit from the remote link partner.

Example 44 includes the subject matter of any of Examples 36-43, and further including means for determining whether the total insertion loss has a predetermined relationship to a predetermined specification limit; means for determining whether the remote FEC ability bit is set; and means for activating the communication link using FEC in response to determining that the remote FEC ability is set, that the total insertion loss does not have the predetermined relationship to the FEC limit, and that the total insertion loss has the predetermined relationship to the specification limit.

Example 45 includes the subject matter of any of Examples 36-44, and further including means for determining whether the FEC ability bit is set; wherein the means for activating the communication link using FEC further comprises means for activating the communication link using FEC in response to determining the FEC ability bit is set.

Example 46 includes the subject matter of any of Examples 36-45, and wherein the means for transmitting the local host insertion loss information comprises means for encoding the local host insertion loss information in an autonegotiation base page; and means for transmitting the autonegotiation base page to the remote link partner.

Example 47 includes the subject matter of any of Examples 36-46, and wherein the means for transmitting the local host insertion loss information comprises means for encoding the local host insertion loss information in an autonegotiation next page; and means for transmitting the autonegotiation next page to the remote link partner.

Example 48 includes the subject matter of any of Examples 36-47, and wherein the means for transmitting the local host insertion loss information comprises means for encoding the local host insertion loss information in a physical medium dependent (PMD) control frame; and means for transmitting the PMD control frame to the remote link partner.

Example 49 includes the subject matter of any of Examples 36-48, and wherein the means for determining the total insertion loss comprises means for adding the local host insertion loss, the remote host insertion loss, and a cable loss to determine the total insertion loss.

Example 50 includes the subject matter of any of Examples 36-49, and further including means for determining the cable loss using a cable management interface.

Example 51 includes the subject matter of any of Examples 36-50, and wherein the communication link with the remote link partner comprises a 25-gigabit copper cable link.

1. A network interface circuit for exchanging capabilities information, the network interface circuit comprising network port logic including:
an exchange module to (i) transmit local host insertion loss information to a remote link partner and (ii) receive remote host insertion loss information from the remote link partner; and
a link activation module to:
determine a total insertion loss as a function of the local host insertion loss information and the remote host insertion loss information;
determine whether the total insertion loss has a predetermined relationship to a predetermined forward error correction (FEC) limit; and
activate a communication link with the remote link partner without using FEC in response to a determination that the total insertion loss has the predetermined relationship with the FEC limit.

2. The network interface circuit of claim 1, wherein the link activation module is further to:
determine whether the total insertion loss has a predetermined relationship to a predetermined specification limit; and
activate the communication link using FEC in response to a determination that the total insertion loss does not have the predetermined relationship to the FEC limit and a determination that the total insertion loss has the predetermined relationship to the specification limit.

3. The network interface circuit of claim 2, wherein the link activation module is further to deactivate the communication link in response to a determination that the total insertion loss does not have the predetermined relationship to the specification limit.

4. The network interface circuit of claim 1, wherein:
the local host insertion loss information comprises a host class selected from a standard loss host or a high loss host; and
the remote host insertion loss information comprises a host class selected from a standard loss host or a high loss host.

5. The network interface circuit of claim 1, wherein:
the local host insertion loss information comprises a local host loss value; and
the remote host insertion loss information comprises a remote host loss value.

6. The network interface circuit of claim 1, wherein the exchange module is further to:
transmit an FEC ability bit and an FEC request bit to the remote link partner; and
receive a remote FEC ability bit and a remote FEC request bit from the remote link partner.

7. The network interface circuit of claim 6, wherein the link activation module is further to:
determine whether the total insertion loss has a predetermined relationship to a predetermined specification limit;
determine whether the remote FEC ability bit is set; and
activate the communication link using FEC in response to a determination that the remote FEC ability is set, a determination that the total insertion loss does not have the predetermined relationship to the FEC limit, and a determination that the total insertion loss has the predetermined relationship to the specification limit.

8. The network interface circuit of claim 1, further comprising an autonegotiation module, wherein the autonegotiation module includes the exchange module, and wherein to transmit the local host insertion loss information comprises to:
encode the local host insertion loss information in an autonegotiation base page; and
transmit the autonegotiation base page to the remote link partner.

9. The network interface circuit of claim 1, further comprising an autonegotiation module, wherein the autonegotiation module includes the exchange module, and wherein to transmit the local host insertion loss information comprises to:
encode the local host insertion loss information in an autonegotiation next page; and
transmit the autonegotiation next page to the remote link partner.

10. The network interface circuit of claim 1, further comprising a physical medium dependent (PMD) module, wherein the PMD module includes the exchange module, and wherein to transmit the local host insertion loss information comprises to:
encode the local host insertion loss information in a physical medium dependent (PMD) control frame; and
transmit the PMD control frame to the remote link partner.

11. The network interface circuit of claim 1, wherein to determine the total insertion loss comprises to add the local host insertion loss, the remote host insertion loss, and a cable loss to determine the total insertion loss.

12. The network interface circuit of claim 1, wherein the communication link with the remote link partner comprises a 25-gigabit copper cable link.

13. A method for exchanging capabilities information, the method comprising:
transmitting, by a network port logic, local host insertion loss information to a remote link partner;
receiving, by the network port logic, remote host insertion loss information from the remote link partner;
determining, by the network port logic, a total insertion loss as a function of the local host insertion loss information and the remote host insertion loss information;
determining, by the network port logic, whether the total insertion loss has a predetermined relationship to a predetermined forward error correction (FEC) limit; and
activating, by the network port logic, a communication link with the remote link partner without using FEC in response to determining that the total insertion loss has the predetermined relationship with the FEC limit.

14. The method of claim 13, further comprising:
determining, by the network port logic, whether the total insertion loss has a predetermined relationship to a predetermined specification limit; and
activating, by the network port logic, the communication link using FEC in response to determining that the total insertion loss does not have the predetermined relationship to the FEC limit and that the total insertion loss has the predetermined relationship to the specification limit.

15. The method of claim 13, wherein:
the local host insertion loss information comprises a host class selected from a standard loss host or a high loss host; and
the remote host insertion loss information comprises a host class selected from a standard loss host or a high loss host.

16. The method of claim 13, further comprising:
transmitting, by the network port logic, an FEC ability bit and an FEC request bit to the remote link partner; and
receiving, by the network port logic, a remote FEC ability bit and a remote FEC request bit from the remote link partner.

17. The method of claim 16, further comprising:
determining, by the network port logic, whether the total insertion loss has a predetermined relationship to a predetermined specification limit;
determining, by the network port logic, whether the remote FEC ability bit is set; and
activating, by the network port logic, the communication link using FEC in response to determining that the remote FEC ability is set, that the total insertion loss does not have the predetermined relationship to the FEC limit, and that the total insertion loss has the predetermined relationship to the specification limit.

18. The method of claim 13, wherein determining the total insertion loss comprises adding the local host insertion loss, the remote host insertion loss, and a cable loss to determine the total insertion loss.

19. One or more computer-readable storage media comprising a plurality of instructions that in response to being executed cause a network port logic to:
transmit local host insertion loss information to a remote link partner;
receive remote host insertion loss information from the remote link partner;
determine a total insertion loss as a function of the local host insertion loss information and the remote host insertion loss information;
determine whether the total insertion loss has a predetermined relationship to a predetermined forward error correction (FEC) limit; and
activate a communication link with the remote link partner without using FEC in response to determining that the total insertion loss has the predetermined relationship with the FEC limit.

20. The one or more computer-readable storage media of claim 19, further comprising a plurality of instructions that in response to being executed cause the network port logic to:
determine whether the total insertion loss has a predetermined relationship to a predetermined specification limit; and
activate the communication link using FEC in response to determining that the total insertion loss does not have the predetermined relationship to the FEC limit and that the total insertion loss has the predetermined relationship to the specification limit.

21. The one or more computer-readable storage media of claim 19, wherein:
the local host insertion loss information comprises a host class selected from a standard loss host or a high loss host; and
the remote host insertion loss information comprises a host class selected from a standard loss host or a high loss host.

22. The one or more computer-readable storage media of claim 19, further comprising a plurality of instructions that in response to being executed cause the network port logic to:
transmit an FEC ability bit and an FEC request bit to the remote link partner; and
receive a remote FEC ability bit and a remote FEC request bit from the remote link partner.

23. The one or more computer-readable storage media of claim 22, further comprising a plurality of instructions that in response to being executed cause the network port logic to:
determine whether the total insertion loss has a predetermined relationship to a predetermined specification limit;
determine whether the remote FEC ability bit is set; and
activate the communication link using FEC in response to determining that the remote FEC ability is set, that the total insertion loss does not have the predetermined relationship to the FEC limit, and that the total insertion loss has the predetermined relationship to the specification limit.

24. The one or more computer-readable storage media of claim 19, wherein to determine the total insertion loss comprises to add the local host insertion loss, the remote host insertion loss, and a cable loss to determine the total insertion loss.
